(19) United States
(12) Patent Application Publication
(10) Pub. No.: US 2024/0265663 A1
(43) Pub. Date: Aug. 8, 2024

(54) SYSTEMS AND METHODS FOR RECOGNIZING PRODUCT LABELS AND PRODUCTS LOCATED ON PRODUCT STORAGE STRUCTURES OF PRODUCT STORAGE FACILITIES

(71) Applicant: Walmart Apollo, LLC, Bentonville, AR (US)

(72) Inventors: Zhaoliang Duan, Frisco, TX (US); Mingquan Yuan, Flower Mound, TX (US); Paul Lewis Lobo, Irving, TX (US); Lingfeng Zhang, Dallas, TX (US); Avinash M. Jade, Bangalore (IN); Yutao Tang, Allen, TX (US)

(21) Appl. No.: 18/106,269

(22) Filed: Feb. 6, 2023

(51) Int. Cl. G06V 10/10; B25J 5/00; G06Q 10/087; G06T 7/70; G06V 10/25; G06V 30/10

(52) U.S. Cl. CPC G06V 10/16; B25J 5/007; G06Q 10/087; G06T 7/70; G06V 10/25; G06V 30/10; G06T 2207/20132; G06V 2201/07

(57) ABSTRACT

Systems and methods of pairing product labels with products located on a product storage structure of a product storage facility include an image capture device that captures one or more images of the product storage structure and a computing device that obtains images of the product storage structure captured by the image capture device, analyzes the obtained images to detect product labels and products located on the product storage structure, and crops the detected individual products and individual price tag labels from the images to generate cropped images. Then the computing device stitches the cropped price tag label and product images, receives one or more characters extracted from the portions of the stitched images corresponding to the cropped images, and associates, based on known positional coordinates of the products and product labels in the stitched images, the received extracted characters with corresponding cropped images of the products and product labels.

### TECHNICAL FIELD

This disclosure relates generally to managing inventory at product storage facilities, and in particular, to recognizing on-shelf product labels and products at a product storage facility.

### BACKGROUND

A typical product storage facility (e.g., a retail store, a product distribution center, a warehouse, etc.) may have hundreds of shelves and thousands of products stored on the shelves and/or on pallets. Individual products offered for sale to consumers are typically stocked on shelves, pallets, and/or each other in a product storage space having a price tag label assigned thereto. It is common for workers of such product storage facilities to manually (e.g., visually) inspect product display shelves and other product storage spaces to verify which of the on-shelf price tag labels are match with which of the on-shelf products, and whether the shelves storing the on-shelf products are correctly labeled with appropriate price tag labels. Given the large number of product storage areas such as shelves, pallets, and other product displays at product storage facilities of large retailers, and the even larger number of products stored in the product storage areas, manual inspection of the price tag labels and the products on the product storage structures at the product storage facilities by the workers is very time consuming and significantly increases the operations cost for a retailer, since these workers could be performing other tasks if they were not involved in manually inspecting the product storage structures, price tag labels, and products.

On the other hand, optical character-based recognition of on-shelf product labels and on-shelf products based on hundreds or thousands of images captured at hundreds/thousands of product storage facilities, each of the images depicting a distinct on-shelf product label or on-shelf product requires significant system resources and/or high processing costs for large retailers.

### BRIEF DESCRIPTION OF THE DRAWINGS

Disclosed herein are embodiments of systems and methods for use in processing images of product labels and products located on a product storage structure of a product storage facility. This description includes drawings, wherein:

FIG. 1 is a diagram of an exemplary system for use in processing images of product labels and products located on a product storage structure of a product storage facility in accordance with some embodiments, depicting a front view of a product storage structure storing various products thereon, the product storage structure being monitored by an image capture device that is configured to move about the product storage facility;

FIG. 2 comprises a block diagram of an exemplary image capture device in accordance with some embodiments;

FIG. 3 is a functional block diagram of an exemplary computing device in accordance with some embodiments;

FIG. 4 is a diagram of an exemplary image of the product storage structure of FIG. 1 taken by the image capture device, showing the product storage structure of FIG. 1 and all of the products and price tag labels thereon;

FIG. 5 is a diagram of the exemplary image of FIG. 4, after the image is processed to detect the individual products and the price tag label located on the product storage structure and to generate virtual boundary lines around each of the products and the price tag labels detected in the image;

FIGS. 6A-6F are diagrams of an enlarged portions of the image of FIG. 5, after the image is processed to crop out the six different price tag labels and the six different products from the image of FIG. 4 to facilitate meta data extraction from, and optical character recognition of, the price tag labels and the products;

FIG. 7A is a diagram of an exemplary stitched image that is generated by stitching together the cropped images of the price tag labels depicted in FIGS. 6A-6F;

FIG. 7B is a diagram of an exemplary stitched image that is generated by stitching together the cropped images of the products depicted in FIGS. 6A-6F;

FIG. 8A is a diagram of the exemplary stitched image of FIG. 7A, after the stitched image is processed via optical character recognition;

FIG. 8B is a diagram of the exemplary stitched image of FIG. 7B, after the stitched image is processed via optical character recognition;

FIG. 9A is a diagram of the exemplary cropped images from the stitched image of FIG. 8A being shown in association with the characters extracted from them during optical character recognition;

FIG. 9B is a diagram of the exemplary cropped images from the stitched image of FIG. 8B being shown in association with the characters extracted from them during optical character recognition;

FIG. 10 is a diagram of an exemplary stitched image that is generated by stitching together cropped images of price tag labels and cropped images of products;

FIG. 11 is a flow diagram of an exemplary process of processing images of product labels and products located on a product storage structure of a product storage facility in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required.

The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally, systems and methods of processing images of product labels and products located on a product storage structure of a product storage facility include an image capture device that captures images of the product storage structure and a computing device that obtains images of the product storage structure captured by the image capture device, analyzes the obtained images to detect price tag labels and products located on the product storage structure, and crops the detected individual products and individual price tag labels from the images to generate cropped images. Then the computing device stitches the cropped price tag label and product images, receives one or more characters extracted from the portions of the stitched images corresponding to the cropped images, and associates, based on known positional coordinates of the products and product labels in the stitched images, the received extracted characters with corresponding cropped images of the products and product labels.

In some embodiments, a system for use in processing images of product labels and products located on a product storage structure of a product storage facility includes an image capture device having a field of view that includes at least a portion of the product storage structure and being configured to capture one or more images of the product storage structure, and a computing device including a control circuit, the computing device being communicatively coupled to the image capture device. The control circuit of the computing device is configured to: obtain at least one image of the product storage structure captured by the image capture device; analyze the at least one image of the product storage structure captured by the image capture device to detect at least one of individual ones of product labels and products located on the product storage structure; crop each one of the detected individual products and each one of the detected individual product labels from the at least one image to generate a plurality of cropped images, each of the cropped images depicting an individual one of the detected products or an individual one of the detected product labels; stitch together two or more of the cropped images to generate at least one stitched image; receive one or more characters extracted from each of the products and each of the product labels detected in the at least one stitched image; and associate, based on known positional coordinates of each of the products and each of the product labels in the at least one stitched image, the received one or more characters extracted from each one of the individual products and product labels detected in the at least one stitched image with corresponding ones of the plurality of cropped images of the products and product labels.

In some embodiments, a method of processing images of product labels and products located on a product storage structure of a product storage facility includes: capturing one or more images of the product storage structure with an image capture device having a field of view that includes at least a portion of the product storage structure; and by a computing device including a control circuit and being communicatively coupled to the image capture device: obtaining at least one image of the product storage structure captured by the image capture device; analyzing the at least one image of the product storage structure captured by the image capture device to detect at least one of individual ones of product labels and products located on the product storage structure; cropping each one of the detected individual products and each one of the detected individual product labels from the at least one image to generate a plurality of cropped images, each of the cropped images depicting an individual one of the detected products or an individual one of the detected product labels; stitching together two or more of the cropped images to generate at least one stitched image; receiving one or more characters extracted from each of the products and each of the product labels detected in the at least one stitched image; and associating, based on known positional coordinates of each of the products and each of the product labels in the at least one stitched image, the received one or more characters extracted from each one of the individual products and product labels detected in the at least one stitched image with corresponding ones of the plurality of cropped images of the products and product labels.

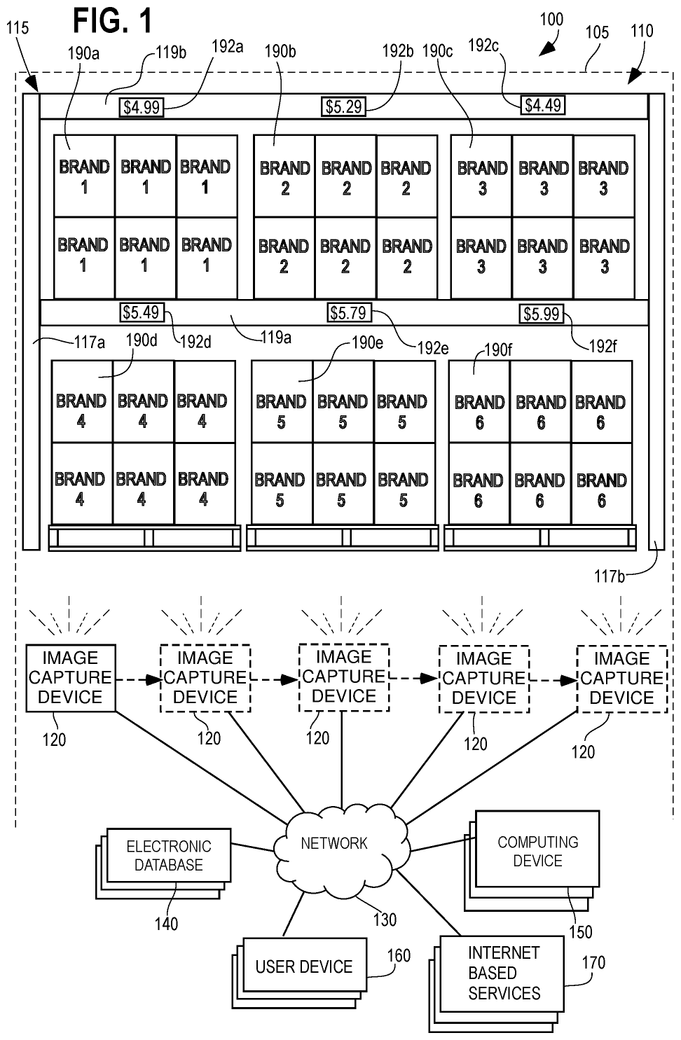

FIG. 1 shows an exemplary embodiment of a system 100 of processing images 180 of product labels 192a-192f (which may be on-shelf labels containing product information and/or on-shelf price tag labels, and/or on-product price tag labels, etc.) and products 190a-190f located on a product storage structure 115 of a product storage facility 105 (which may be a retail store, a product distribution center, a warehouse, etc.). The system 100 is illustrated in FIG. 1 for simplicity with only one movable image capture device 120 that moves about one product storage area 110 containing one product storage structure 115, but it will be appreciated that, depending on the size of the product storage facility 105 being monitored, the system 100 may include multiple movable image capture devices 120 located at the product storage facility 105 that monitor hundreds or thousands of product storage areas 110 and product storage structures 115.

It is understood that the direction and type of movement of the image capture device 120 about the product storage area 110 of the product storage facility 105 may depend on the physical arrangement of the product storage area 110 and/or the size and shape of the product storage structure 115. For example, the image capture device 120 may move linearly down an aisle alongside a product storage structure 115 (e.g., a shelving unit) located in a product storage area 110 of a product storage facility 105, or may move in a circular fashion around a table having curved/multiple sides. Notably, the term “product storage structure” as used herein generally refers to a structure on which products 190a-190f are stored, and may include a pallet, a shelf cabinet, a single shelf, table, rack, refrigerator, freezer, displays, bins, gondola, case, countertop, or another product display. Likewise, it will be appreciated that the number of individual products 190a-190f representing six individual units of each of six different exemplary products (generically labeled as “Brand 1,” “Brand 2,” “Brand 3,” “Brand 4,” Brand 5,” and “Brand 6”) is chosen for simplicity and by way of example only, and that the product storage structure 115 may store more or less than six units of each of the products 190a-190f. Further, the size and shape of the products 190a-190f in FIG. 1 have been shown by way of example only, and it will be appreciated that the individual products 190a-190f may have various sizes and shapes.

Notably, the term “products” may refer to individual products 190a-190f (some of which may be single-piece/single-component products and some of which may be multi-piece/multi-component products), as well as to packages or containers of products 190a-190f, which may be plastic- or paper-based packaging that includes multiple units of a given product 190a-190f (e.g., a plastic wrap that includes 36 rolls of identical paper towels, a paper box that includes 10 packs of identical diapers, etc.). Alternatively, the packaging of the individual products 190a-190f may be a plastic- or paper-based container that encloses one individual product 190a-190f (e.g., a box of cereal, a bottle of shampoo, etc.).

Notably, while the product labels 192a-192f may be referred to herein as “on-shelf product labels” or “on-shelf price tag labels,” it will be appreciated that the product labels 192a-192f do not necessarily have to be affixed to horizontal support members 119a or 119b (which may be shelves, etc.) of the product support structure 115 as shown in FIG. 1 and may be located in a different location (e.g., on the vertical support members 117a-117b (which may be support posts interconnecting the shelves).

The image capture device 120 (also referred to as an image capture unit or a motorized robotic unit) of the exemplary system 100 depicted in FIG. 1 may be configured for movement about the product storage facility 105 (e.g., on the floor via a motorized or non-motorized wheel-based and/or track-based locomotion system, or via slidable tracks above the floor, etc.) such that, when moving (e.g., about an aisle or other area of a product storage facility 105), the image capture device 120 has a field of view that includes at least a portion the product storage structure 115 within the product storage area 110 of the product storage facility 105, permitting the image capture device 120 to capture multiple images of the product storage area 110 and the product storage structure 115 from various viewing angles. In some embodiments, the image capture device 120 is configured as a robotic device that moves without being physically operated/manipulated by a human operator (as described in more detail below). In other embodiments, the image capture device 120 is configured to be driven or manually pushed (e.g., like a cart or the like) by a human operator. In still further embodiments, the image capture device 120 may be a hand-held or a wearable device (e.g., a camera, phone, tablet, or the like) that may be carried and/or work by a worker at the product storage facility 105 while the worker moves about the product storage facility 105. In some embodiments, the image capture device 120 may be incorporated into another mobile device (e.g., a floor cleaner, floor sweeper, forklift, etc.), the primary purpose of which is independent of capturing images of product storage areas 110 of the product storage facility 105.

In some embodiments, as will be described in more detail below, the images 180 of the product storage area 110 captured by the image capture device 120 while moving about the product storage area 110 are transmitted by the image capture device 120 over a network 130 to an electronic database 140 and/or to a computing device 150. In some aspects, the computing device 150 (or a separate image processing internet based/cloud-based service module) is configured to process such images as will be described in more detail below.

The exemplary system 100 includes an electronic database 140. Generally, the exemplary electronic database 140 of FIG. 1 may be configured as a single database, or a collection of multiple communicatively connected databases (e.g., digital image database, meta data database, inventory database, vertical and horizontal support member positional coordinate database, cropped images database, stitched images database, pricing database, customer database, vendor database, manufacturer database, etc.) and may be configured to store various raw and processed images (e.g., 180, 182, 184, 186, 187a-187b, 188a-188b) of the product storage structure 115 captured by the image capture device 120 while the image capture device 120 may be moving about the product storage facility 105. In some embodiments, the electronic database 140 and the computing device 150 may be implemented as two separate physical devices located at the product storage facility 105. It will be appreciated, however, that the computing device 150 and the electronic database 140 may be implemented as a single physical device and/or may be located at different (e.g., remote) locations relative to each other and relative to the product storage facility 105. In some aspects, the electronic database 140 may be stored, for example, on non-volatile storage media (e.g., a hard drive, flash drive, or removable optical disk) internal or external to the computing device 150, or internal or external to computing devices distinct from the computing device 150. In some embodiments, the electronic database 140 may be cloud-based. In some embodiments, the electronic database 140 may be an Azure Redis Cache.

The system 100 of FIG. 1 further includes a computing device 150 (which may be one or more computing devices as pointed out below) configured to communicate with the electronic database 140 (which may be one or more databases as pointed out below), the image capture device 120, user device 160 (which may be one or more user devices as pointed out below), and/or internet-based service 170 (which may be one or more internet-based services as pointed out below) over the network 130. The exemplary network 130 depicted in FIG. 1 may be a wide-area network (WAN), a local area network (LAN), a personal area network (PAN), a wireless local area network (WLAN), Wi-Fi, Zigbee, Bluetooth (e.g., Bluetooth Low Energy (BLE) network), or any other internet or intranet network, or combinations of such networks. Generally, communication between various electronic devices of system 100 may take place over hard-wired, wireless, cellular, Wi-Fi or Bluetooth networked components or the like. In some embodiments, one or more electronic devices of system 100 may include cloud-based features, such as cloud-based memory storage. In some embodiments, the one or more computing devices 150, one or more electronic databases 140, one or more user devices 160, and/or portions of the network 130 are located at, or in the product storage facility 105.

The computing device 150 may be a stationary or portable electronic device, for example, a desktop computer, a laptop computer, a single server or a series of communicatively connected servers, a tablet, a mobile phone, or any other electronic device including a control circuit (i.e., control unit) that includes a programmable processor. The computing device 150 may be configured for data entry and processing as well as for communication with other devices of system 100 via the network 130. As mentioned above, the computing device 150 may be located at the same physical location as the electronic database 140, or may be located at a remote physical location relative to the electronic database 140.

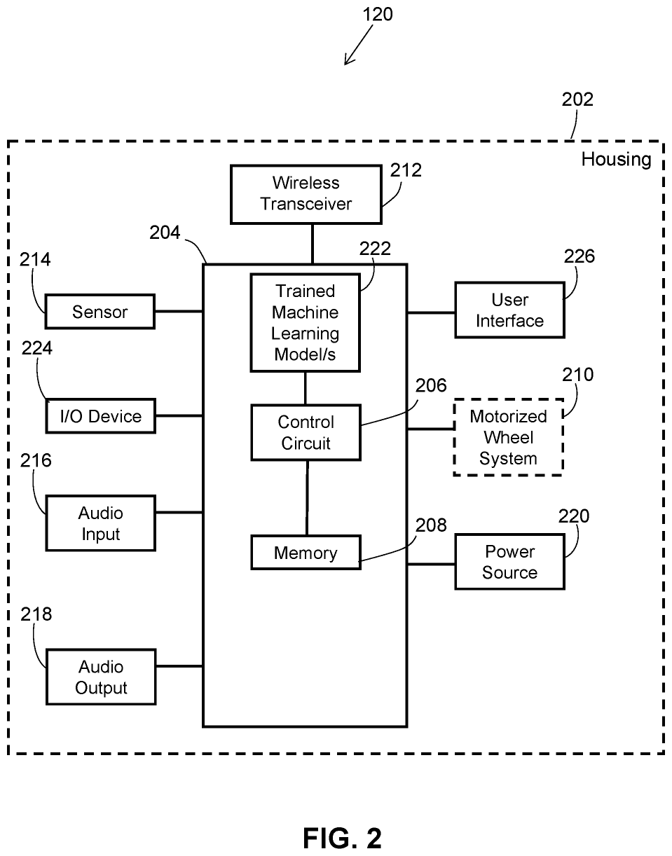

FIG. 2 presents a more detailed example of an exemplary motorized robotic image capture device 120. As mentioned above, the image capture device 120 does not necessarily need an autonomous motorized wheel-based and/or track-based system to move about the product storage facility 105, and may instead be moved (e.g., driven, pushed, carried, worn, etc.) by a human operator, or may be movably coupled to a track system (which may be above the floor level or at the floor level) that permits the image capture device 120 to move about the product storage facility 105 while capturing images of various product storage areas 110 of the product storage facility 105. In the example shown in FIG. 2, the motorized image capture device 120 has a housing 202 that contains (partially or fully) or at least supports and carries a number of components. These components include a control unit 204 comprising a control circuit 206 that controls the general operations of the motorized image capture device 120 (notably, in some implementations, the control circuit 310 of the computing device 150 may control the general operations of the image capture device 120). Accordingly, the control unit 204 also includes a memory 208 coupled to the control circuit 206 that stores, for example, computer program code, operating instructions and/or useful data, which when executed by the control circuit implement the operations of the image capture device.

The control circuit 206 of the exemplary motorized image capture device 120 of FIG. 2, operably couples to a motorized wheel system 210, which, as pointed out above, may be optional (and for this reason represented by way of dashed lines in FIG. 2). This motorized wheel system 210 functions as a locomotion system to permit the image capture device 120 to move within the product storage facility 105 (thus, the motorized wheel system 210 may be more generically referred to as a locomotion system). Generally, this motorized wheel system 210 may include at least one drive wheel (i.e., a wheel that rotates about a horizontal axis) under power to thereby cause the image capture device 120 to move through interaction with, e.g., the floor of the product storage facility 105. The motorized wheel system 210 can include any number of rotating wheels and/or other alternative floor-contacting mechanisms (e.g., tracks, etc.) as may be desired and/or appropriate to the application setting.

The motorized wheel system 210 may also include a steering mechanism of choice. One simple example may comprise one or more wheels that can swivel about a vertical axis to thereby cause the moving image capture device 120 to turn as well. It should be appreciated that the motorized wheel system 210 may be any suitable motorized wheel and track system known in the art capable of permitting the image capture device 120 to move within the product storage facility 105. Further elaboration in these regards is not provided here for the sake of brevity save to note that the aforementioned control circuit 206 may be configured to control the various operating states of the motorized wheel system 210 to thereby control when and how the motorized wheel system 210 operates.

In the exemplary embodiment of FIG. 2, the control circuit 206 operably couples to at least one wireless transceiver 212 that operates according to any known wireless protocol. This wireless transceiver 212 can comprise, for example, a Wi-Fi-compatible and/or Bluetooth-compatible transceiver (or any other transceiver operating according to known wireless protocols) that can wirelessly communicate with the aforementioned computing device 150 via the aforementioned network 130 of the product storage facility 105. So configured, the control circuit 206 of the image capture device 120 can provide information to the computing device 150 (via the network 130) and can receive information and/or movement instructions from computing device 150. For example, the control circuit 206 can receive instructions from the computing device 150 via the network 130 regarding directional movement (e.g., specific predetermined routes of movement) of the image capture device 120 throughout the space of the product storage facility 105. These teachings will accommodate using any of a wide variety of wireless technologies as desired and/or as may be appropriate in a given application setting. These teachings will also accommodate employing two or more different wireless transceivers 212, if desired.

In the embodiment illustrated in FIG. 2, the control circuit 206 also couples to one or more on-board sensors 214 of the image capture device 120. These teachings will accommodate a wide variety of sensor technologies and form factors. According to some embodiments, the image capture device 120 can include one or more sensors 214 including but not limited to an optical sensor, a photo sensor, an infrared sensor, a 3-D sensor, a depth sensor, a digital camera sensor, a laser imaging, detection, and ranging (LIDAR) sensor, a mobile electronic device (e.g., a cell phone, tablet, or the like), a quick response (QR) code sensor, a radio frequency identification (RFID) sensor, a near field communication (NFC) sensor, a stock keeping unit (SKU) sensor, a barcode (e.g., electronic product code (EPC), universal product code (UPC), European article number (EAN), global trade item number (GTIN)) sensor, or the like.

By one optional approach, an audio input 216 (such as a microphone) and/or an audio output 218 (such as a speaker) can also operably couple to the control circuit 206. So configured, the control circuit 206 can provide a variety of audible sounds to thereby communicate with workers at the product storage facility 105 or other motorized image capture devices 120 moving about the product storage facility 105. These audible sounds can include any of a variety of tones and other non-verbal sounds. Such audible sounds can also include, in lieu of the foregoing or in combination therewith, pre-recorded or synthesized speech.

The audio input 216, in turn, provides a mechanism whereby, for example, a user (e.g., a worker at the product storage facility 105) provides verbal input to the control circuit 206. That verbal input can comprise, for example, instructions, inquiries, or information. So configured, a user can provide, for example, an instruction and/or query (e.g., where is product storage structure number so-and-so?, how many products are stocked on product storage structure so-and-so? etc.) to the control circuit 206 via the audio input 216.

In the embodiment illustrated in FIG. 2, the motorized image capture device 120 includes a rechargeable power source 220 such as one or more batteries. The power provided by the rechargeable power source 220 can be made available to whichever components of the motorized image capture device 120 require electrical energy. By one approach, the motorized image capture device 120 includes a plug or other electrically conductive interface that the control circuit 206 can utilize to automatically connect to an external source of electrical energy to thereby recharge the rechargeable power source 220.

In some embodiments, the motorized image capture device 120 includes an input/output (I/O) device 224 that is coupled to the control circuit 206. The I/O device 224 allows an external device to couple to the control unit 204. The function and purpose of connecting devices will depend on the application. In some examples, devices connecting to the I/O device 224 may add functionality to the control unit 204, allow the exporting of data from the control unit 206, allow the diagnosing of the motorized image capture device 120, and so on.

In some embodiments, the motorized image capture device 120 includes a user interface 226 including for example, user inputs and/or user outputs or displays depending on the intended interaction with the user (e.g., worker at the product storage facility 105). For example, user inputs could include any input device such as buttons, knobs, switches, touch sensitive surfaces or display screens, and so on. Example user outputs include lights, display screens, and so on. The user interface 226 may work together with or separate from any user interface implemented at an optional user interface unit or user device 160 (such as a smart phone or tablet device) usable by a worker at the product storage facility 105. In some embodiments, the user interface 226 is separate from the image capture device 120, e.g., in a separate housing or device wired or wirelessly coupled to the image capture device 120. In some embodiments, the user interface 226 may be implemented in a mobile user device 160 carried by a person (e.g., worker at product storage facility 105) and configured for communication over the network 130 with the image capture device 120.

In some embodiments, the motorized image capture device 120 may be controlled by the computing device 150 or a user (e.g., by driving or pushing the image capture device 120 or sending control signals to the image capture device 120 via the user device 160) on-site at the product storage facility 105 or off-site. This is due to the architecture of some embodiments where the computing device 150 and/or user device 160 outputs the control signals to the motorized image capture device 120. These controls signals can originate at any electronic device in communication with the computing device 150 and/or motorized image capture device 120. For example, the movement signals sent to the motorized image capture device 120 may be movement instructions determined by the computing device 150; commands received at the user device 160 from a user; and commands received at the computing device 150 from a remote user not located at the product storage facility 105.

In the embodiment illustrated in FIG. 2, the control unit 204 includes a memory 208 coupled to the control circuit 206 and that stores, for example, computer program code, operating instructions and/or useful data, which when executed by the control circuit implement the operations of the image capture device. The control circuit 206 can comprise a fixed-purpose hard-wired platform or can comprise a partially or wholly programmable platform. These architectural options are well known and understood in the art and require no further description here. This control circuit 206 may be configured (for example, by using corresponding programming stored in the memory 208 as will be well understood by those skilled in the art) to carry out one or more of the steps, actions, and/or functions described herein. The memory 208 may be integral to the control circuit 206 or can be physically discrete (in whole or in part) from the control circuit 206 as desired. This memory 208 can also be local with respect to the control circuit 206 (where, for example, both share a common circuit board, chassis, power supply, and/or housing) or can be partially or wholly remote with respect to the control circuit 206. This memory 208 can serve, for example, to non-transitorily store the computer instructions that, when executed by the control circuit 206, cause the control circuit 206 to behave as described herein.

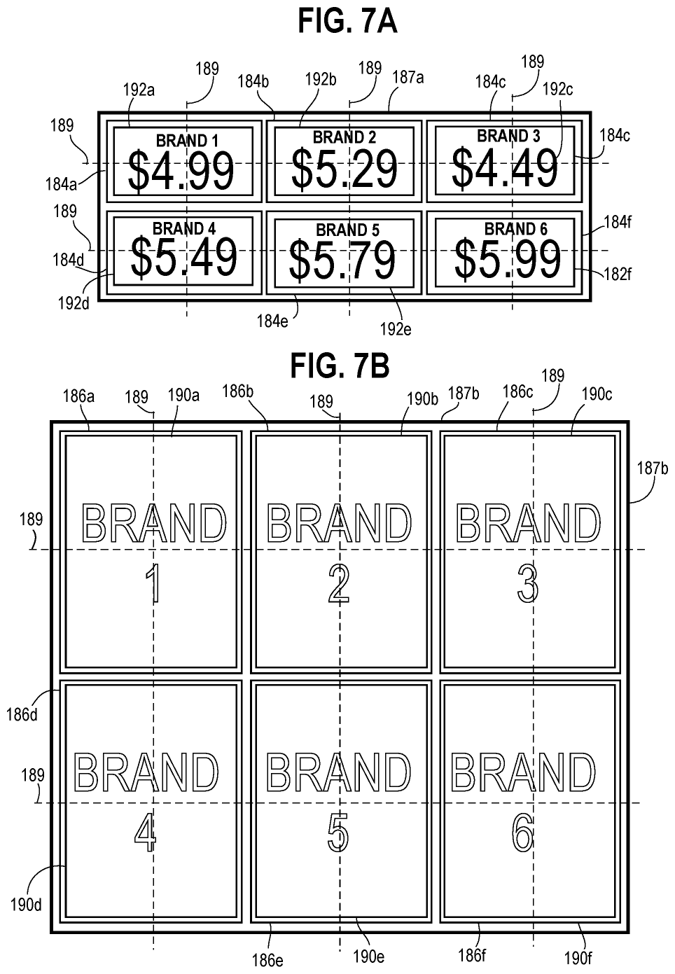

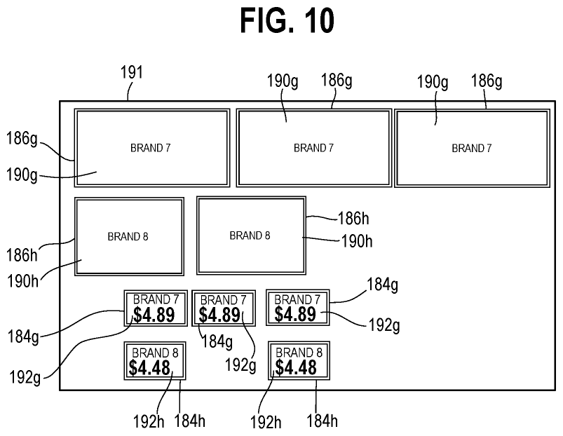

In some embodiments, the control circuit 206 may be communicatively coupled to one or more trained computer vision/machine learning/neural network modules/models 222 to perform at some of the functions. For example, in certain aspects, the control circuit 206 may be trained to process one or more images 180 of product storage areas 110 at the product storage facility 105 to detect and/or recognize one or more products 190a-190f using one or more machine learning algorithms, including but not limited to Linear Regression, Logistic Regression, Decision Tree, SVM, Naive Bayes, kNN, K-Means, Random Forest, Dimensionality Reduction Algorithms, and Gradient Boosting Algorithms. In some embodiments, the trained machine learning module/model 222 includes a computer program code stored in a memory 208 and/or executed by the control circuit 206 to process one or more images 180, as described hereinbelow. In certain implementations, the control circuit 206 may be trained to use the first fit decreasing height algorithm via synchronous architecture or asynchronous architecture to generate stitched images 187a of price tag labels 192a-192f (see FIG. 7A) and/or stitched images 187b of products 190a-190f (see FIG. 7B) and/or stitched images 191 of price tag labels 192a-192f and products 190a-190f (see FIG. 10) as described below.

It is understood that the terms “stitching” or “stitched” as used herein with respect to the images 187a-187b generally mean merging or combining multiple images 184a-184f and/or 186a-186f together to generate a merged or combined image 187a, 187b, or 191. In addition, the term “stitching” as used herein is not limited to a specific way of merging the images 184a-184f and/or 186a-186f and may refer to merging the images 184a-184f and/or 186a-186f into one image such that the edges of the adjacent images 184a-184f and/or 186a-186f coincide, adjoin, or are spaced from one another, or such that portions of the adjacent images 184a-184f and/or 186a-186f overlap one another.

It is noted that not all components illustrated in FIG. 2 are included in all embodiments of the motorized image capture device 120. That is, some components may be optional depending on the implementation of the motorized image capture device 120. It will be appreciated that while the image capture device 120 of FIG. 2 may be a motorized robotic device capable of moving about the product storage facility 105 while being controlled remotely (e.g., by the computing device 150) and without being controlled by an onboard human operator, in some embodiments, the image capture device 120 may be configured to permit an onboard human operator (i.e., driver) to direct the movement of the image capture device 120 about the product storage facility 105.

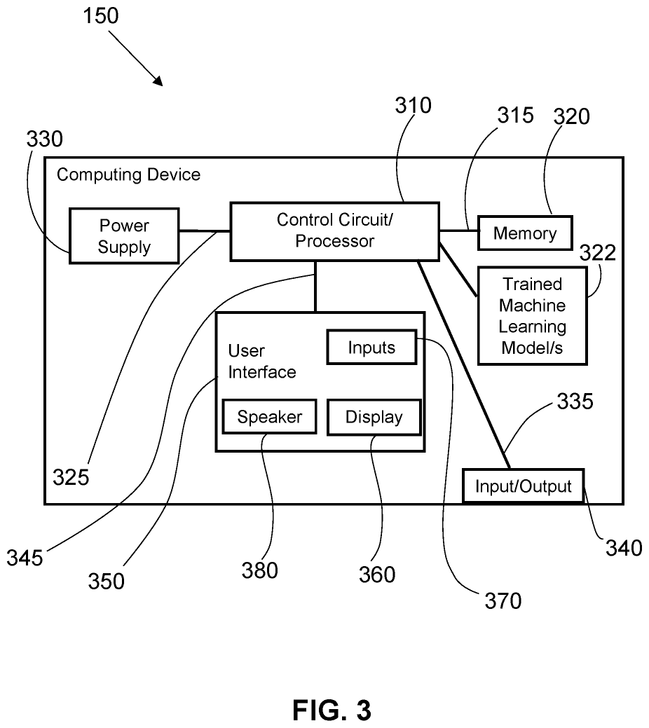

With reference to FIG. 3, the exemplary computing device 150 configured for use with exemplary systems and methods described herein may include a control circuit 310 including a programmable processor (e.g., a microprocessor or a microcontroller) electrically coupled via a connection 315 to a memory 320 and via a connection 325 to a power supply 330. The control circuit 310 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

The control circuit 310 can be configured (for example, by using corresponding programming stored in the memory 320 as will be well understood by those skilled in the art) to carry out one or more of the steps, actions, and/or functions described herein. In some embodiments, the memory 320 may be integral to the processor-based control circuit 310 or can be physically discrete (in whole or in part) from the control circuit 310 and may be configured to non-transitorily store the computer instructions that, when executed by the control circuit 310, cause the control circuit 310 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control unit may be referred to as a non-transitory medium or non-transitory computer readable medium.

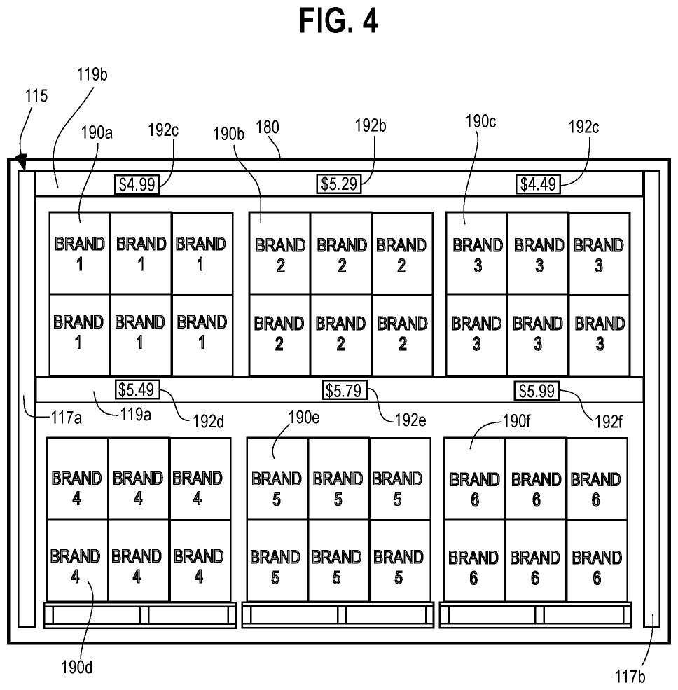

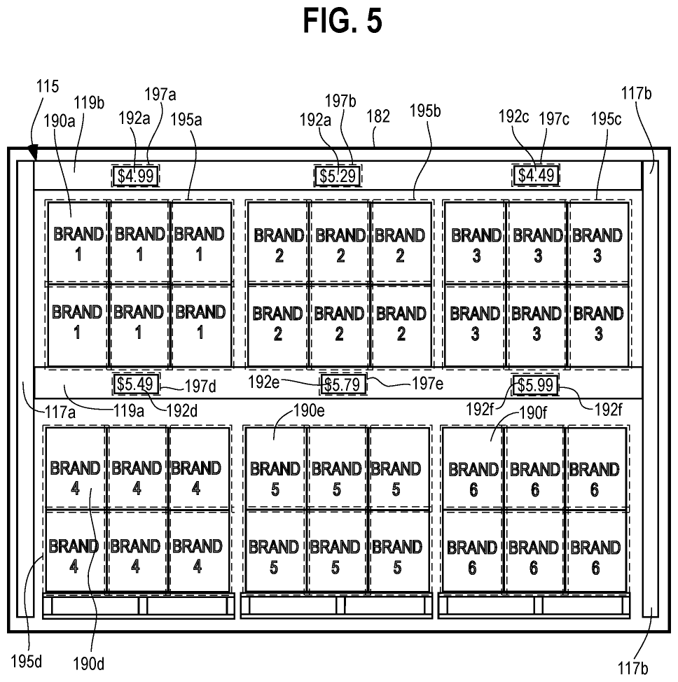

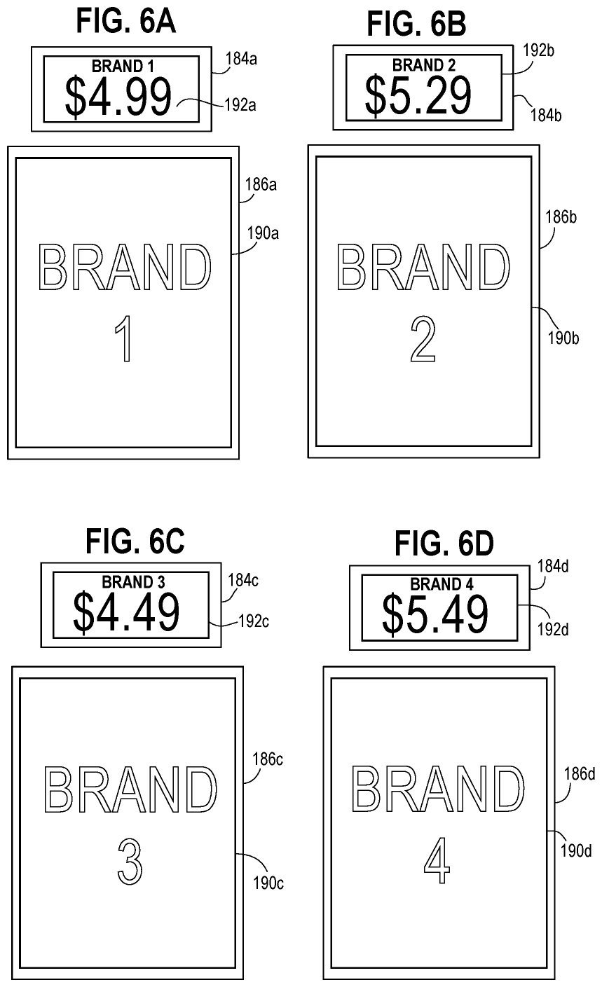

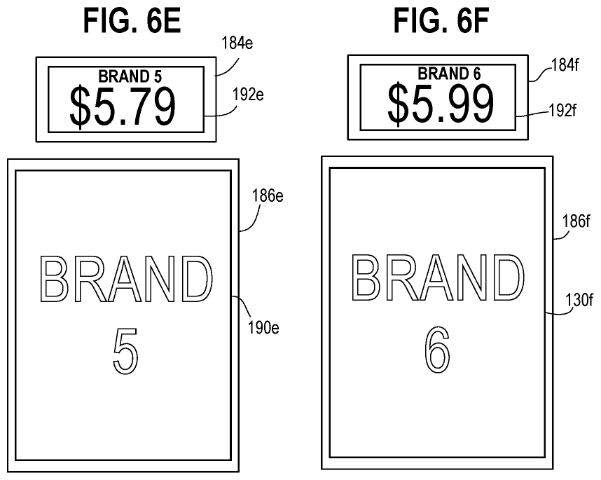

The control circuit 310 of the computing device 150 may be also electrically coupled via a connection 335 to an input/output 340 that can receive signals from, for example, from the image capture device 120, the electronic database 140, internet-based service 170 (e.g., one or more of an image processing service, computer vision service, neural network service, etc.), and/or from another electronic device (e.g., an electronic device or user device 160 of a worker tasked with physically inspecting the product storage area 110 and/or the product storage structure 115 and observing the individual products 190 stocked thereon). The input/output 340 of the computing device 150 can also send signals to other devices, for example, a signal to the electronic database 140 including a raw image 180 of a product storage structure 115 as shown in FIG. 4, or a processed image 182 of the product storage structure 115 as shown in FIG. 5, or a cropped image 184a-184f of a product (e.g., price tag) label 192a as shown in FIGS. 6A-6F, or a cropped image 186a-186f of a product 190a-190f as shown in FIGS. 6A-6F. Also, a signal may be sent by the computing device 150 via the input/output 340 to the image capture device 120 to, e.g., provide a route of movement for the image capture device 120 through the product storage facility 105.

The processor-based control circuit 310 of the computing device 150 shown in FIG. 3 may be electrically coupled via a connection 345 to a user interface 350, which may include a visual display or display screen 360 (e.g., LED screen) and/or button input 370 that provide the user interface 350 with the ability to permit an operator of the computing device 150 (e.g., worker at a the product storage facility 105 (or a worker at a remote regional center) tasked with monitoring the inventory and/or ensuring the products 190a-190f are correctly labeled with the product labels 192a-192f at the product storage facility 105 to manually control the computing device 150 by inputting commands via touch-screen and/or button operation and/or voice commands. Possible commands may, for example, cause the computing device 150 to cause transmission of an alert signal to electronic mobile user device/s 160 of a worker/s at the product storage facility 105 to assign a task to the worker that requires the worker to, e.g., visually inspect and/or relabel a given product storage structure 115 based on analysis by the computing device 150 of the image 180 of the product storage structure 115 captured by the image capture device 120.

In some embodiments, the user interface 350 of the computing device 150 may also include a speaker 380 that provides audible feedback (e.g., alerts) to the operator of the computing device 150. It will be appreciated that the performance of such functions by the processor-based control circuit 310 of the computing device 150 may not be dependent on a human operator, and that the control circuit 310 of the computing device 150 may be programmed to perform such functions without a human operator.

As pointed out above, in some embodiments, the image capture device 120 moves about the product storage facility 105 (while being controlled remotely by the computing device 150 (or another remote device such one or more user devices 160)), or while being controlled autonomously by the control circuit 206 of the image capture device 120), or while being manually driven or pushed by a worker of the product storage facility 105. When the image capture device 120 moves about the product storage area 110 as shown in FIG. 1, the sensor 214 of the image capture device 120, which may be one or more digital cameras, captures (in sequence and at predetermined intervals) multiple images of the product storage area 110 and the product storage structure 115 from various angles. In certain aspects, the image capture device 120 is configured to move about the product storage area 110 while capturing one or more images 180 of the product storage structure 115 at certain predetermined time intervals (e.g., every 1 second, 5 seconds, 10 seconds, etc.). The images 180 captured by the image capture device 120 may be transmitted to the electronic database 140 for storage and/or to the computing device 150 for processing by the control circuit 310 and/or to a web-/cloud-based image processing service 170.

In some aspects, the control circuit 310 of the computing device 150 obtains (e.g., from the electronic database 140, or from an image-processing internet-based service 170, or directly from the image capture device 120) one or more images 180 of the product storage area 110 captured by the image capture device 120 while moving about the product storage area 110. In particular, in some aspects, the control circuit 310 of the computing device 150 is programmed to process a raw image 180 shown in FIG. 4 (which may be captured by the image capture device 120 (as depicted in FIG. 1) and obtained by the computing device 150 from the electronic database 140, or from the image capture device 120) to extract the raw image data and meta data from the image 180. In some aspects, the image 180 captured by the image capture device 120 may be processed via web-/cloud-based image processing service 170, which may be installed on the computing device 150 (or communicatively coupled to the computing device 150) and executed by the control circuit 310.

In some embodiments, the meta data extracted from the image 180 captured by the image capture device 120, when processed by the control circuit 310 of the computing device 150, enables the control circuit 310 of the computing device 150 to detect the physical location of the portion of the product storage area 110 and/or product storage structure 115 depicted in the image 180 and/or the physical locations and characteristics (e.g., size, shape, etc.) of the individual products 190a-190f and the price tag labels 192a-192f depicted in the image 180.

With reference to FIGS. 4 and 5, in some aspects, the control circuit 310 of the computing device 150 is configured to process the data extracted from the image 180 captured by the image capture device 120 to detect the overall size and shape of each of the individual products 190a-190f and product (e.g., price tag) labels 192a-192f located on the product storage structure 115 captured in the image 180. In some embodiments, the control circuit 310 is configured to process the data extracted from the image 180 and detect each of the individual products 190a-190f and product labels 192a-192f in the image 180 by executing one or more machine learning and/or computer vision modules and/or trained neural network modules/models 322. In certain aspects, the neural network executed by the control circuit 310 may be a deep convolutional neural network. The neural network module/model 322 may be trained using various data sets, including, but not limited to: raw image data extracted from the images 180 captured by the image capture device 120; meta data extracted from the images 180 captured by the image capture device 120; reference image data associated with reference images of various product storage structures 115 at the product storage facility 105; reference images of various products 190a-190f stocked and/or sold at the product storage facility 105; and reference images of various product labels 192a-192f applied to product storage structures 115 (or to products 190a-190f) at product storage facility 105.

In some embodiments, the control circuit 310 may be trained to process one or more images 180 of product storage areas 110 at the product storage facility 105 to detect and/or recognize one or more products 190 using one or more computer vision/machine learning algorithms, including but not limited to Linear Regression, Logistic Regression, Decision Tree, SVM, Naive Bayes, kNN, K-Means, Random Forest, Dimensionality Reduction Algorithms, and Gradient Boosting Algorithms. In some embodiments, the trained machine learning/neural network module/model 322 includes a computer program code stored in a memory 320 and/or executed by the control circuit 310 to process one or more images 180, as described herein. It will be appreciated that, in some embodiments, the control circuit 310 does not process the raw image 180 shown in FIG. 4 to result in the processed image 182 shown in FIG. 5, and that such processing may be performed by an internet-based service 170, after which the processed image 182 may be obtained by the control circuit 310 for further analysis.

In some aspects, the control circuit 310 may be configured to process the data extracted from the image 180 via computer vision and one or more trained neural networks to detect each of the individual products 190a-190f and each of the individual price tag labels 192a-192f located on the product storage structure 115 in the image 180, and to generate virtual boundary lines 195a-195f (as seen in image 182 in FIG. 5) around each one of the individual products 190a-190f detected in the image 180. By the same token, in some aspects, the control circuit 310 may be configured to process the data extracted from the image 180 via computer vision and one or more trained neural networks to detect each one of the individual product (in this exemplary case, price tag) labels 192a-192f located on the product storage structure 115 in the image 180, and to generate a virtual boundary line 197a-197f (as seen in image 182 in FIG. 5) around each of the individual product labels 192a-192f detected in the image 180. Notably, the terms “virtual boundary lines” and “virtual bounding boxes” are used interchangeably herein.

It is understood that as used herein, the term “bounding box” is intended to be any shape that surrounds or defines boundaries about a detected object in an image. That is, abounding box may be in the shape of a square, rectangle, circle, oval, triangle, and so on, or may be any irregular shape having curved, angled, straight and/or irregular sections within which the object is located, the irregular shape may loosely conform to the shape of the object or not. Further, a bounding box may not be complete in that it could include open sections (such that the bounding box is formed by connecting the dots). In any event, embodiments of a bounding box can be defined as a shape that surrounds or defines boundaries about a detected object. And generally, to illustrate examples of some embodiments in one or more figures, bounding boxes are illustrated in square or rectangular form.

As seen in the image 182 in FIG. 5, the virtual boundary lines 195a-195f extend about the outer edges of each of the individual products 190a-190f located on the product storage structure 115, and form a perimeter around each of the individual products 190a-190f. Similarly, the virtual boundary lines 197a-197f extend about the outer edges of each of the individual price tag labels 192a-192f located on the product storage structure 115, and form a perimeter around each of the individual price tag labels 192a-192f. Generally, the control circuit 310 may be programmed to interpret each of the virtual boundary lines 195a-195f as surrounding only one individual product 190a-190f, and to interpret each of the virtual boundary lines 197a-197f as surrounding only one individual price tag label 192a-192f.

In some embodiments, after generating the virtual boundary lines 195a-195f around the products 190 and the virtual boundary lines 197a-197f around the price tag labels 192a-192f, the control circuit 310 of the computing device 150 is programmed to cause the computing device 150 to transmit a signal including the processed image 182 over the network 130 to the electronic database 140 for storage. In one aspect, this image 182 may be used by the control circuit 310 in subsequent image detection operations and/or training or retraining a neural network model as a reference model of a visual representation of the product storage structure 115 and/or products 190a-190f and/or price tag labels 192a-192f.

More specifically, in some implementations, the control circuit 310 is programmed to perform object detection analysis with respect to images subsequently captured by the image capture device 120 by utilizing machine learning/computer vision modules/models 322 that may include one or more neural network models trained using the image data stored in the electronic database 140. Notably, in certain aspects, the machine learning/neural network modules/models 322 may be retrained based on physical inspection of the product storage structure 115 and/or products 190a-190f and/or price tag labels 192a-192f by a worker of the product storage facility 105, and in response to an input received from an electronic user device 160 of the worker.

In certain embodiments, as will be discussed in more detail below with reference to FIGS. 6A-9B, after the control circuit 310 detects the products 190a-190f and the price tag labels 192a-192f on the product storage structure 115 in images 180 and 182, the control circuit 310 may be programmed to process the image 180 to crop out the detected products 190a-190f and product labels 192a-192f. As mentioned above, while FIG. 4 shows (for ease of illustration) only one image 180 of the product storage structure 115 and describes the analysis of this image 180 by the control circuit 310 of the computing device 150, it will be appreciated that, in some embodiments, the control circuit 310 may process and analyze dozens or hundreds of images 180 of the product storage structure 115 (and, in some aspects, dozens or hundreds of other product storage structures 115 at the product storage facility 105) that are captured (at pre-determined intervals) by the image capture device 120 while moving about the product storage facility 105, and the images 180 may be processed by the control circuit 310 as raw images 180 or as processed images 182 (e.g., pre-processed by an image-processing and/or neural network-based internet-based service 170).

In some implementations, after the image 180 obtained by the computing device 150 is processed by the control circuit 310 as described above to generate the image 182 of FIG. 5 including virtual boundary lines 195a-195f around each of the individual products 190a-190f and virtual boundary lines 197a-197f around each of the individual price tag labels 192a-192f, the control circuit 310 may be programmed to further process the image 182 to crop each individual product 190a-190f from the image 182 and to crop each individual product (e.g., price tag) label 192a-192f from the image 182, thereby resulting in images 184a-184f (depicting the product labels 192a-192f) and images 186a-186f depicting the products 190a-190f, as shown in FIGS. 6A-6F. It is understood that processing the image 182 to crop each individual product 190 from the image 182 and create the cropped image 186 is one example of the image processing that may be performed by the control circuit 310, and that, in some embodiments, instead of cropping out an image 186a-186f of the product 190 from the image 182, the control circuit 310 may copy/record the pixel data corresponding to the corresponding product 190a-190f in the image 182, and just use the pixel data associated with the product 190 instead of using the cropped image 186 depicting the product 190.

Then, in some embodiments, the control circuit 310 processes each of the individual cropped images 184a-184f respectively depicting the product labels 192a-192f to stitch them together, thereby forming a stitched image 187a, which includes all six of the product labels 192a-192f detected in the image 180 as shown in FIG. 7A. Notably, as pointed out above, while the present application shows only one image 180 of one product storage structure 115 containing six product (e.g., price tag) labels 192a-192f thereon, it is understood that the control circuit 310 may analyze multiple (dozens, hundreds, thousands) images 180 of storage structures 115, which would result in the generation of a stitched image 187a that may be composed of significantly more than six (e.g., dozens, hundreds, thousands) cropped images 184a-184f, and that contains significantly more (e.g., dozens, hundreds, thousands) of product labels 192a-192f thereon. It should also be noted that, while the stitched image 187a depicts only product labels 192a-192f, in some embodiments, the control circuit 310 is programmed to create a stitched image 191 that depicts both product labels (192g and 192h) and products (190g and 190h), as seen in FIG. 10.

In some embodiments, the control circuit 310 processes each of the individual cropped images 186a-186f respectively depicting individual products 190a-190f to stitch them together, thereby forming a stitched image 187b, which includes all six of the products 190a-190f detected in the image 180 as shown in FIG. 7B. Notably, as pointed out above, while the present application shows only one image 180 of one product storage structure 115 containing six products 190a-190f thereon, it is understood that the control circuit 310 may analyze multiple (dozens, hundreds, thousands) images 180 of storage structures 115, which would result in the generation of a stitched image 187b that may be composed of significantly more than six (e.g., dozens, hundreds, thousands) cropped images 186a-186f, and that contains significantly more (e.g., dozens, hundreds, thousands) of products thereon. Notably while the stitched image 187b depicts only products 190a-190f, in some embodiments, the control circuit 310 is programmed to create a stitched image 191 that depicts both product labels (192g and 192h) and products (190g and 190h), as seen in FIG. 10.

In some embodiments, the stitched image 187a and the stitched image 187b may have a predetermined pixel size (e.g., from 1200×1200 to 5000×5000). Since the pixel size of the stitched image 187a permits the stitching together of a large number of cropped images of price tag labels 192a-192f (i.e., more than just the six exemplary cropped images 184a-184f illustrated in FIGS. 6A-6F), and since the pixel size of the stitched image 187b permits the stitching together of a large number of cropped images of products 190a-190f (i.e., more than just the six exemplary cropped images 186a-186f illustrated in FIGS. 6A-6F), in some embodiments, the control circuit 310 is programmed to employ an algorithm that optimizes the space of the stitched images 187a-187 when stitching the cropped images 184a-184f (and others, if applicable) into the image 187a and when stitching the cropped images 186a-186f (and others, if applicable) into the image 187b.

In one aspect, the control circuit 310 is programmed to employ a first fit decreasing height algorithm to maximally populate the stitched image 187a with the cropped images 184a-184f of the price tag labels 192a-192f, and to maximally populate the stitched image 187b with the cropped images 186a-186f of the price tag labels 192a-192f Without wishing to be limited to theory, generally, the first-fit-decreasing height is an algorithm for packing objects into a defined space (a stitched image having a defined pixel size), the input being a list of items (e.g., cropped images of various price tag labels and/or cropped images of various products) of different sizes, and the output being a packing of the items into the defined space, such that the sum of the sizes of the items fitted into the defined space is at maximum possible capacity. In other words, the implementation of the first-fit-decreasing height algorithm by the control circuit 310 when adding the cropped images 184a-184f into the stitched image 187a and when adding the cropped images 186a-186f into the stitched image 187b is to fit as many cropped images of the price tag labels 192a-192f into a single stitched image 187a, and to fit as many cropped images of the products 190a-190f into a single stitched image 187b.

Since, as pointed out in the preceding paragraph, in some embodiments, the control circuit 310 may stitch cropped images 184 of price tag labels 192 that originate from more than one image 180 of one product storage structure 115, and stitch cropped images 186 of products 190 that originate from more than one image 180 of one product storage structure 115, in certain implementations, the control circuit 310 is programmed to select synchronous architecture or asynchronous architecture as appropriate when populating the stitched images 187a and 187b with the cropped images 184 and 186, respectively. For example, when the control circuit 310 determines that the use of synchronous architecture would result in a more optimal space (i.e., pixel) utilization of the stitched images 187a-187b, in one implementation, the control circuit is programmed to stitch the cropped images 186a-186f of the individual ones of the products 190a-190f to generate the stitched image 187a and to stitch the cropped images 184a-184f of the individual ones of the price tag labels 192a-192f to generate the stitched image 187b by implementing a synchronous architecture in combination with the first fit decreasing height algorithm. On the other hand, when the control circuit 310 determines that the use of asynchronous architecture would result in a more optimal space (i.e., pixel) utilization of the stitched images 187a-187b, in one implementation, the control circuit is programmed to stitch the cropped images 186a-186f of the individual ones of the products 190a-190f to generate the stitched image 187a and to stitch the cropped images 184a-184f of the individual ones of the price tag labels 192a-192f to generate the stitched image 187b by implementing an asynchronous architecture in combination with the first fit decreasing height algorithm.

In addition, while the exemplary stitched images 187a and 187b shown in FIGS. 7A and 7B are shown with the cropped images 184a-184f of the product labels 192a-192f and cropped images 186a-186f of the products 190a-190f being fitted in to optimally maximize the available pixels of their respective stitched images 187a-187b, the relative locations of the cropped images 184a-184f and 186a-186f in their respective stitched images 187a-187b are shown by way of example only, and the locations of, as well as the spaces between the cropped images 184a-184f and 186a-186f in their respective stitched images 187a-187b may be different. For example, in some embodiments, depending on the number of cropped images being stitched together to generate a stitched image, the control unit 310 may generate a stitched image 191 as shown in FIG. 10, where some of the spacing between some of the adjacent product labels 184g and 184h and between some of the adjacent products 190g and 190h may be different, and where not all of the available pixel space in the stitched image 192 is filled in by a product label 184g-184h or a product 190g-190h (i.e., the available pixel space that remains in the stitched image 191 would permit the addition of one or more of the cropped images 186g-186h of the products 190g-190h and/or the addition of one or more of the cropped images 184g-184h of the product labels 190g-190h.

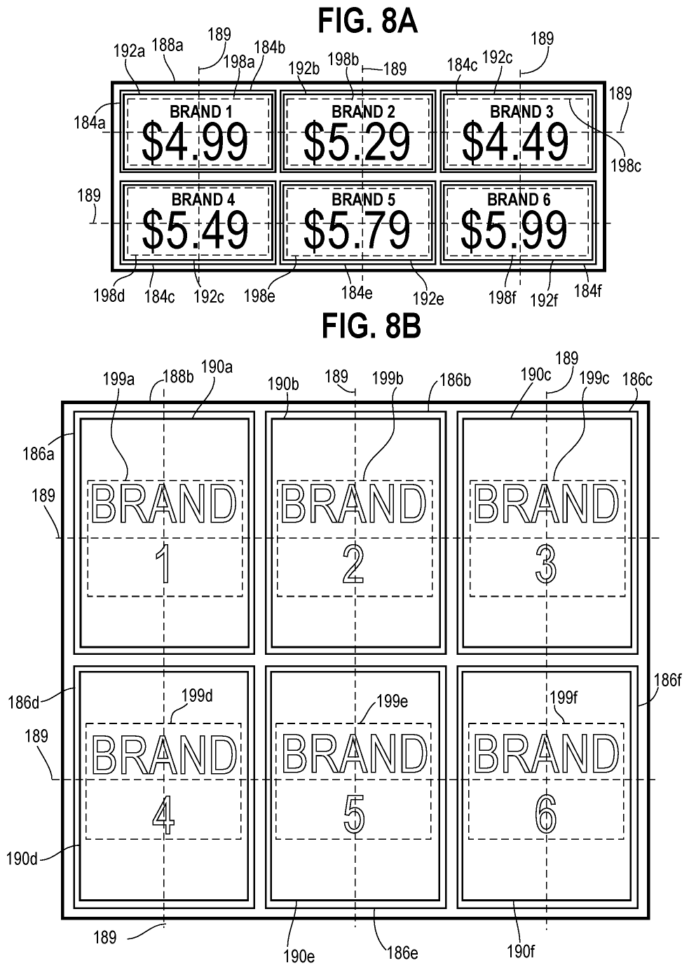

In certain embodiments, to ensure proper organization of the cropped images 184a-184f within the stitched image 187a, as well as proper organization of the cropped images 186a-186f within the stitched image 187b, the control circuit 310 is programmed to assign a positional coordinate to each of the cropped images 184a-184f of the product (e.g., price tag) labels 192a-192f populated into the stitched image 187a and to assign a positional coordinate to each of the cropped images 186a-186f of the products 190a-190f populated into the stitched image 187b. As mentioned above, the assignment of the positional coordinates to the product labels 192a-192f in FIGS. 7A and 8A and the assignment of the positional coordinates to the products 190a-190f in FIGS. 7A and 8B is schematically indicated by vertical and horizontal grid-line dashed lines 189.

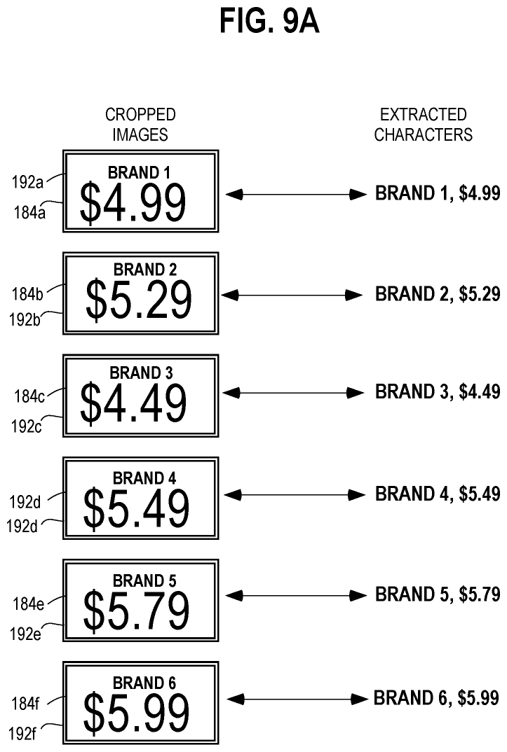

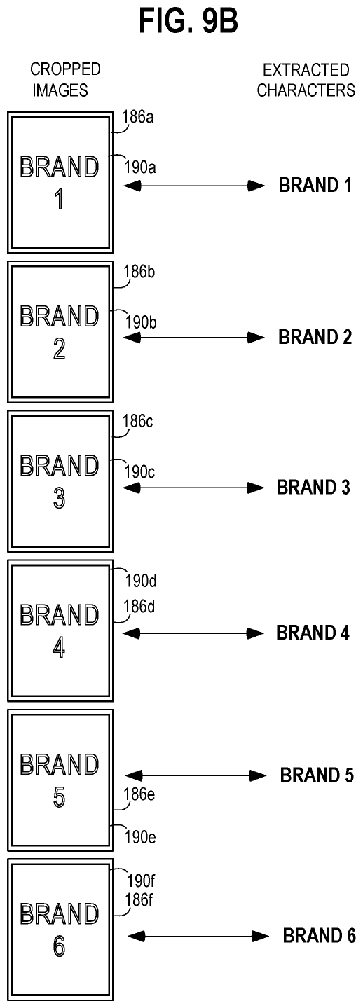

The assignment of a positional coordinate (as schematically indicated by the dashed lines 189 in FIGS. 7A-7B and 8A-8B) to each of the cropped images 184a-184f within the stitched image 187a and to each of the cropped images 186a-186f within the stitched image 187b enables the control circuit 310 to determine the actual location of each of the cropped images 184a-184f within the stitched image 187a, as well as the actual location of each of the cropped images 186a-186f within the stitched image 187b, which facilitates the subsequent association of the cropped images 184a-184f of the product labels 192a-192f and cropped images 186a-186f of the products 190a-190f to these extracted characters (e.g., keywords, numbers, symbols, etc. as seen in FIGS. 9A-9B) during character extraction (e.g., optical recognition) processing, as discussed below.

With reference to FIGS. 8A, and 8B, in some embodiments, after generating the stitched image 187a depicting the product (e.g., price tag) labels 192a-192f, and after generating the stitched image 187b depicting the products 190a-190f, the control circuit 310 is programmed to transmit each of the stitched images 187a-187b to an internet-based service 170 (e.g., Google OCR, etc.), which processes the stitched images 187a-187b by extracting one or more characters (e.g., alphanumeric characters, special characters, images, etc.) from each of the product labels 192a-192f in the stitched image 187a and from each of the products 190a-190f in the stitched image 187b. In some aspects, instead of transmitting the stitched images 187a-187b to an internet-based service 170 for optical character processing, the control circuit 310 may be programmed to process the stitched images 187a-187b by extracting one or more characters (e.g., alphanumeric characters, special characters, images, etc.) from each of the product labels 192a-192f in the stitched image 187a and from each of the products 190a-190f in the stitched image 187b.

In some embodiments, if the control circuit 310 (or the internet-based service 170) is unable to perform OCR processing of any of the product labels 192a-192f in the stitched image 187a or any of the products 190a-190f in the stitched image 187b (e.g., because one or more of the price tag labels 192a-192f and/or products 190a-190f in the image 187a and/or 187b is partially occluded), the control circuit 310 (or the internet-based service 170) is programmed to generate an alert indicating that OCR processing of certain of the product labels 192a-192f and/or products 190a-190f in the stitched images 187a-187b was not successful.

In some embodiments, the control circuit 310 of the computing device 150 (or the internet-based service 170) processes/analyzes the meta data extracted from the product labels 192a-192f in the stitched image 187a to identify one or more alphanumeric characters (e.g., keywords, symbols, numbers, etc. as shown in the exemplary image 188a in FIG. 8A). Similarly, in some embodiments, the control circuit 310 of the computing device 150 (or the internet-based service 170) processes/analyzes the meta data extracted from the products 190a-190f in the stitched image 187b to identify one or more alphanumeric characters (e.g., keywords, symbols, numbers, etc. as shown in the exemplary image 188b in FIG. 8B).

With reference to FIG. 8A, after the control circuit 310 (or the internet-based service 170) extracts the characters (e.g., via OCR) from the cropped images 184a-184f depicting the price tag labels 192a-192f and detects a keyword in the extracted data, the control circuit 310 converts the detected keyword to a keyword instance that indicates the keyword (i.e., each letter or number or character of the keyword) on each price tag label 192a-192f For example, in the stitched image 187a of FIG. 8A, the control circuit 310 (or the internet-based service 170) detected on the price tag label 192a of the cropped image 184a the keyword “BRAND 1” (which indicates the brand name of product 190a) and detected the price (i.e., $4.99) of the product 190a associated with the product label 192a (the optical character recognition being represented by a virtual bounding box 198a around the detected keyword “BRAND 1” and the detected product price “$4.99” on the price tag label 192a). By the same token, in the stitched image 187a of FIG. 8A, the control circuit 310 (or the internet-based service 170) detected on the product labels 192b-192f of the cropped images 184b-184f the keywords “BRAND 2-BRAND 6,” respectively, and detected the prices “$5.29, $4.49, $5.49, $5.79, and $5.99”, respectively, (the optical character recognition being represented by virtual bounding boxes 198b-198f, respectively, around the detected keywords “BRAND 2-BRAND 6” and the detected product prices “$5.29, $4.49, $5.49, $5.79, and $5.99” on the respective price tag labels 192b-192f in the stitched image 187a of FIG. 8A).

With reference to FIG. 8B, after the control circuit 310 (or the internet-based service 170) extracts the characters (e.g., via OCR) from the cropped images 186a-186f depicting the products 190a-190f and detects a keyword in the extracted data, the control circuit 310 converts the detected keyword to a keyword instance that indicates the keyword (i.e., each letter or number or character of the keyword). For example, in the stitched image 187b of FIG. 8B, the control circuit 310 (or the internet-based service 170) detected on the product 190a of cropped image 186a the keyword “BRAND 1” (which indicates the brand name of product 190a) (the optical character recognition being represented by a virtual bounding box 199a around the detected keyword “BRAND 1”). By the same token, in the stitched image 187b of FIG. 8B, the control circuit 310 (or the internet-based service 170) detected on the price tag labels 192b-192f of cropped images 186b-186f the keywords “BRAND 2-BRAND 6,” respectively, (the optical character recognition being represented by virtual bounding boxes 199b-199f, respectively, around the detected keywords “BRAND 2-BRAND 6” on the products 190b-190f in the stitched image 187b).

In some embodiments, after the characters on the products 190a-190f in stitched image 187b and price tag labels 192a-192f in stitched image 187a are detected by the control circuit 310 and/or obtained by the control circuit 310 from an internet-based service 170, the control circuit 310 associates the characters detected on the products 190a-190f and product labels 192a-192f to the cropped images 184a-184f of the product labels 192a-192f and to the cropped images 186a-186f of the products 190a-190f, respectively. As pointed out above, the control circuit 310 assigns a positional coordinate 189 to each of the cropped images 184a-184f of the price tag labels 192a-192f populated into the stitched image 187a and to each of the cropped images 184a-184f of the products 190a-190f populated into the stitched image 187b.

Accordingly, in some embodiments, after the control circuit 310 obtains the characters extracted from the cropped images 184a-184f of the product labels 192a-192f in stitched image 187a, the control circuit 310 is able to determine the exact location of a cropped image 184a-184f that depicts a price tag label 192a-192f that matches the characters extracted from the corresponding portion of the stitched image 187a, which allows the control circuit 310 to associate the characters extracted from the portions of the stitched image 187a corresponding to the cropped images 184a-184f of the price tag labels 192a-192f to the correct price tag label 192a-192f, as shown in FIG. 9A. For example, in the exemplary embodiment shown in FIG. 9A, after the control circuit 310 obtains the characters extracted from the portions of the stitched image 187a corresponding to the cropped images 184a-184f of the price tag labels 192a-192f, since the positional coordinates (represented by the grid-like dashed lines 189 in FIGS. 7A-7B and 8A-8B) and thus the exact location of each cropped image 184a-184f in the stitched image 187a that was processed (e.g., via optical character recognition) are known, the control circuit 310 associates each of the product labels 192a-192f detected in the stitched image 187a with the characters (text, numbers, etc.) extracted from the portion of the stitched image 187a corresponding to a respective one of cropped images 184a-184f respectively depicting the product labels 192a-192f.

With reference to FIG. 9A, this association of the cropped images 184a-184f detected in the stitched image 187a with the characters extracted from the portion of the stitched image 187a corresponding to a respective one of product labels 192a-192f results in the following associations: the cropped image 184a depicting the product label 192a is associated with the text “BRAND 1” and the special characters/numbers “$4.99” extracted by the control circuit 310 (or the internet-based service 170) from the portion of the stitched image 187a corresponding to the cropped image 184a; the cropped image 184b depicting the product label 192b is associated with the text “BRAND 2” and the special characters/numbers “$5.29” extracted by the control circuit 310 (or the internet-based service 170) from the portion of the stitched image 187a corresponding to the cropped image 184b; the cropped image 184c depicting the product label 192c is associated with the text “BRAND 3” and the special characters/numbers “$4.49” extracted by the control circuit 310 (or the internet-based service 170) from the portion of the stitched image 187a corresponding to the cropped image 184c; the cropped image 184d depicting the product label 192d is associated with the text “BRAND 4” and the special characters/numbers “$5.49” extracted by the control circuit 310 (or the internet-based service 170) from the portion of the stitched image 187a corresponding to the cropped image 184d; the cropped image 184e depicting the product label 192e is associated with the text “BRAND 5” and the special characters/numbers “$5.79” extracted by the control circuit 310 (or the internet-based service 170) from the portion of the stitched image 187a corresponding to cropped image 184e; and the cropped image 184f depicting the product label 192f is associated with the text “BRAND 6” and the special characters/numbers “$5.99” extracted by the control circuit 310 (or the internet-based service 170) from the portion of the stitched image 187a corresponding to cropped image 184f.

In some embodiments, after the control circuit 310 obtains the characters extracted from the portions of the cropped image 187b corresponding to the cropped images 186a-186f of the products 190a-190f, the control circuit 310 is able to determine the exact location of a cropped image 186a-186f that depicts a product 190a-190f that matches the characters extracted from the stitched image 187b, which allows the control circuit 310 to associate the characters extracted from the portions of the stitched image corresponding to the cropped images 186a-186f of the products 190a-190f to the correct products 190a-190f in the stitched image 187b, as shown in FIG. 9B. In the exemplary embodiment shown in FIG. 9B, after the control circuit 310 obtains the characters extracted from the portions of the stitched image 187b corresponding to the cropped images 186a-186f of the products 190a-190f, since the positional coordinates (represented by the grid-like dashed lines 189 in FIGS. 7A-7B and 8A-8B) and thus the exact location of each cropped image 186a-186f detected in the stitched image 187a that was processed (e.g., via optical recognition) are known, the control circuit 310 associates each of the products 190a-190f with the characters (text, numbers, etc.) extracted from the portion of the stitched image 187b corresponding to a respective one of cropped images 186a-186f respectively depicting the products 190a-190f.

With reference to FIG. 9B, this association of the cropped images 186a-186f detected in the stitched image 187B with the characters extracted from the portion of the stitched image 187B corresponding to a respective one of products 190a-190f results in the following association: the cropped image 186a depicting the product 190a is associated with the text “BRAND 1” extracted by the control circuit 310 (or the internet-based service 170) from the portion of the stitched image 187B corresponding to the cropped image 186a; the cropped image 186b depicting the product 190b is associated with the text “BRAND 2” extracted by the control circuit 310 (or the internet-based service 170) from the portion of the stitched image 187b corresponding to the cropped image 186b; the cropped image 186c depicting the product 190c is associated with the text “BRAND 3” extracted by the control circuit 310 (or the internet-based service 170) from the portion of the stitched image 187b corresponding to the cropped image 184c; the cropped image 186d depicting the product 190d is associated with the text “BRAND 4” extracted by the control circuit 310 (or the internet-based service 170) from the portion of the stitched image 187b corresponding to the cropped image 186d; the cropped image 186e depicting the product 190e is associated with the text “BRAND 5” extracted by the control circuit 310 (or the internet-based service 170) from the portion of the stitched image 187b corresponding to cropped image 186e; and the cropped image 186f depicting the product 192f is associated with the text “BRAND 6” extracted by the control circuit 310 (or the internet-based service 170) from the portion of the stitched image 187b corresponding to cropped image 186f.

In some embodiments, after the characters on the portions of the stitched images 187a-187b corresponding to the product labels 192a-192f and products 190a-190f are detected and associated with their respective cropped images 184a-184f and 186a-186f as shown in FIGS. 9A and 9B above, the control circuit 310 is programmed to correlate the characters extracted from and associated with the product labels 192a-192f and from the products 190a-190f (which may be transmitted by the control circuit 310 to the electronic database 140 for storage) to the inventory data stored in the electronic database 140 to predict the known product identifiers (e.g., UPC code, product name, etc.) that correspond (e.g., match) the characters extracted from the price tag labels 192a-192f and products 190a-190f. For example, in one approach, the control circuit 310 may correlate the potential product identifiers (e.g., names of the products 190a-190f such as “BRAND 1,” “BRAND 2,” and so forth as shown in FIG. 9B) extracted from the products 190a-190f and/or the potential product identifiers (e.g., product names, prices, such as “BRAND 1, $4.99,” “BRAND 2, $5.29,” and so forth as shown in FIG. 9A) extracted from the product labels 192a-192f to electronic product catalog information (obtained by the control circuit 310 from the electronic database 140) indicating the known identifiers of reference products stocked at the product storage facility 105. This correlation may enable the control circuit 310 to predict (with high certainty) which of the cropped images 184a-184f of the product labels 192a-192f and which of the cropped images 186a-186f of the products 190a-190f contain product information that matches the product information stored in the product catalog in the electronic database 140.

For example, if the control circuit 310 determines that a certain catalogued product stored in the electronic database 140 has a product name (“BRAND 1”) and price (“$4.99”) that match the characters (i.e., “BRAND 1” and “$4.99”) extracted from the product label 192a, the control circuit 310 may interpret this result as warranting a prediction that the price tag label 192a in the cropped image 186a is allocated to this catalogued product. By the same token, if the control circuit 310 determines that a certain catalogued product stored in the electronic database 140 has a product name that matches the characters (e.g., product name) extracted from the product 190a, the control circuit 310 may interprets this result as a warranting a prediction that the product 190a in the cropped image 186a matches this catalogued product.

Notably, in some embodiments, if the control circuit 310 determines that the electronic database 140 does not contain a product name (e.g., “BRAND 1”) that matches the characters (i.e., “BRAND 1”) extracted from the cropped image 184a of the price tag label 192a, but contains a product price (i.e., $4.99) that matches the characters (i.e., $4.99) extracted from the cropped image 184a of the price tag label 192a, the control circuit 310 may interpret this result as an indication that the price tag label 192a contains incorrect product name information. Also, if the control circuit 310 determines that the electronic database 140 contains a product name (i.e., “BRAND 1”) that matches the characters (i.e., “BRAND 1”) extracted from the cropped image 184a of the price tag label 192a, but does not contain a product price (i.e., $4.99) that matches the characters (i.e., $4.99) extracted from the cropped image 184a of the price tag label 192a, the control circuit 310 may interpret this result as an indication that the price tag label 192a contains incorrect price information. By the same token, if the control circuit 310 determines that the electronic database 140 does not contain a product name (i.e., “BRAND 1”) that matches the characters (i.e., “BRAND 1”) extracted from the cropped image 186a of the product 190a, the control circuit 310 may interpret this result as an indication that the electronic database 140 contains incorrect product name information. In some embodiments, the control circuit 310 is programmed to generate an alert in cases of mismatching names and/or prices, and this alert may be transmitted by the control circuit 310 to the electronic database 140 and/or to a user device 160 of a worker at the product storage facility 105 to instruct the worker to take remedial action.

In some embodiments, after the control circuit 310 predicts, based on the above-described correlation of the characters extracted from the products 190a-190f and price tag labels 192a-192f to the inventory information stored in the electronic database 140, a known product identifier that may be a match to the labels 184a-184f and/or products 190a-190f in the stitched images 187a-187b, the control circuit 310 is programmed to send a signal to the electronic database 140 to update the electronic database 140 such that each cropped image 186a-186f depicting a product 190a-190f and/or each cropped image 184a-184f depicting a product label 192a-192f is associated with a known product identifier predicted by the control circuit 310 to be a match. In summary, as a result of the exemplary processing of the raw image 180 of a product storage structure 115 containing unidentified products 190a-190f and unidentified product labels 192a-192f that is captured by the image capture device 120, the electronic database 140 may be updated to store cropped images 184a-184f of the product labels and/or cropped images 186a-186f of the products 190a-190f detected on the product storage structure 115, and these stored cropped images 184a-184f and/or 186a-186f stored in the electronic database 140 are associated with their predicted known product identifiers, which in turn facilitates the proper placement of products 190a-190f on the storage structures 115, as well as the proper labeling of the products 190a-190f with product labels 192a-192f.

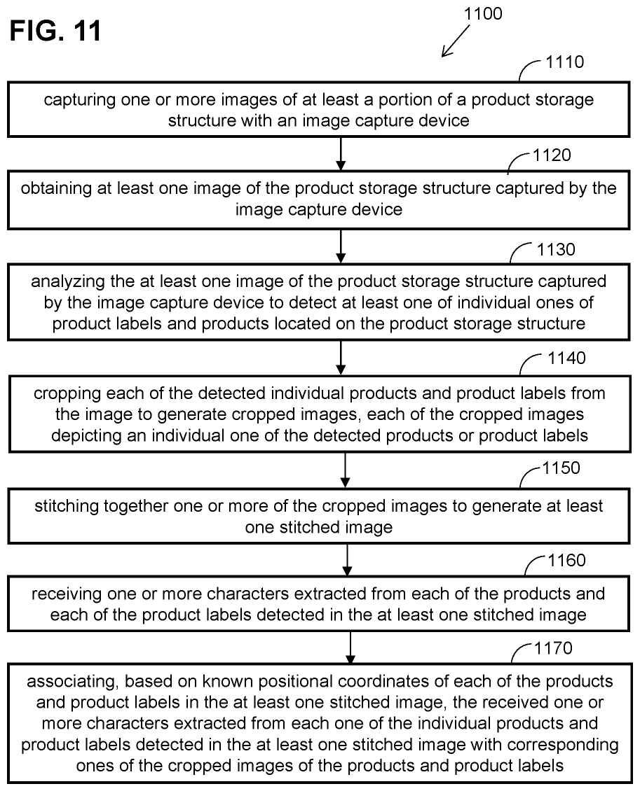

With reference to FIG. 11, an exemplary method 1100 of operation of the system 100 of processing images 180 of product labels 192a-192f and products 190a-190f located on a product storage structure 115 of a product storage facility 105 is described. The method 1100 includes capturing one or more images 180 of the product storage structure 115 with an image capture device 120 having a field of view that includes at least a portion of the product storage structure 115 (step 1110). As pointed out above, the images 180 may be captured by the image capture device 120 while the image capture device 120 is moving about the product storage facility 105. As pointed out above, the image capture device 120 may move about the product storage area 110 while capturing images 180 of the product storage structure 115 at certain predetermined time intervals (e.g., every 1 second, 5 seconds, 10 seconds, etc.), and the images 180 captured by the image capture device 120 may be transmitted to the electronic database 140 for storage and/or to the computing device 150 for processing by the control circuit 310 and/or to a web-/cloud-based image processing service 170.

The method 1100 of FIG. 11 further includes several actions performed by a computing device 150 including a control circuit 310 and communicatively coupled to the image capture device 120. For example, the method 1100 further includes obtaining at least one image 180 of the product storage structure 115 captured by the image capture device 120 (step 1120) and analyzing the at least one image 180 of the product storage structure 115 captured by the image capture device 120 to detect at least one of individual ones of price tag labels 192a-192f and products 190a-190f located on the product storage structure 115 (step 1130). As pointed out above, in some embodiments, the control circuit 310 of the computing device 150 obtains (e.g., from the electronic database 140, or from an image-processing internet-based service 170, or directly from the image capture device 120) one or more images 180 captured by the image capture device 120 and processes the raw image 180 to detect the price tag labels 192a-192f and the products 190a-190f on the product storage structure 115 in the image 180. As described above, in some aspects, during the detection of the price tag labels 192a-192f and products 190a-190f in the image 180, the control circuit 310 generates virtual boundary lines 195a-195f around the products 190a-190f and virtual boundary lines 197a-197f around the price tag labels 192a-192f, as seen in FIG. 5.

With reference to FIG. 11, the exemplary method 100 further includes cropping each one of the detected individual products 190a-190f and each one of the detected individual product labels 192a-192f from the at least one image 180 to generate a plurality of cropped images 186a-186f and 184a-184f (see FIGS. 6A-6F), each of the cropped images 184a-184f or 186a-186f depicting an individual one of the detected product labels 192a-192f or an individual one of the detected products 190a-190f (step 1140). The method 1100 further includes the control circuit 310 processing one or more of the cropped images 184a-184f and/or 186a-186f to stitch them together, thereby forming one or more stitched images 187a (see FIG. 7A that contains only cropped images of product labels 192a-192f), 187b (see FIG. 7B that contains only cropped images of products 190a-190f), and/or 191 (see FIG. 10 that contains cropped images of both product labels 192a-192f and products 190a-190f) (step 1150).

After the control circuit 310 obtains the raw image 180 and processes it to generate the stitched image 187a, 187b, and/or 191 as described above, the exemplary method 1100 further includes the control circuit 310 of the computing device 150 receiving one or more characters (e.g., keywords, symbols, numbers, etc.) extracted from each of the products 190a-190f and each of the product labels 192a-192f detected in the stitched image 187a, 187b, and/or 191 (step 1160). As pointed out above, the characters that are received by the control circuit 310 in step 1160 may be extracted (e.g., by OCR processing) either by an internet-based service 170 (e.g., Google OCR) or by the control circuit 310 itself. In some embodiments, the detected characters are received along with the positional coordinates of the detected characters. For example, the data returned from the OCR processing indicates each detected text or character and its positional coordinates within each of the respective stitched images 187a, 187b. The positional coordinates may be defined in terms of positional regions of the image or x-y pixel ranges of the detected characters, i.e., detected characters “abc” were found at positional coordinates “x10-x40 and y20-y40”.

In the illustrated embodiment, after the control circuit 310 receives the one or more characters extracted (by the internet-based service 170 or by the control circuit 310 itself) from each of the products 190a-190f and each of the product labels 192-192f detected in the at least one stitched image 187a, 187b, and/or 191, the method 1100 further includes associating, based on known positional coordinates of each of the products 190a-190f and product labels 192a-192f in the at least one stitched image 187a-187b, the received one or more characters extracted from each one of the individual products 190a-190f and product labels 192a-192f detected in the at least one stitched image 187a-187b with corresponding ones of the cropped images 186a-186f of the products 190a-190f and corresponding ones of the cropped images 184a-184f of the product labels 192a-192f (step 1170).

As described above, in some embodiments, after the characters on the products 190a-190f in the stitched image 187b and price tag labels 192a-192f in the stitched image 187a are detected by the control circuit 310 and/or obtained by the control circuit 310 from an internet-based service 170, the control circuit 310 associates the characters detected on the products 190a-190f and product labels 192a-192f to the cropped images 184a-184f of the product labels 192a-192f and to the cropped images 186a-186f of the products 190a-190f, respectively, as shown in FIGS. 9A-9B, based on the known positional coordinates 189 of each of the cropped images 184a-184f of the price tag labels 192a-192f populated into the stitched image 187a and based on the known positional coordinates 189 of each of the cropped images 184a-184f of the products 190a-190f populated into the stitched image 187b.

For example, as shown in FIG. 9A, since the positional coordinates and thus the exact location of each cropped image 184a-184f in the stitched image 187a that was processed (e.g., via optical character recognition) are known, the control circuit 310 associates each of the product labels 192a-192f detected in the stitched image 187a with the characters (text, numbers, etc.) extracted from the portions of the stitched image 187a corresponding to a respective one of cropped images 184a-184f respectively depicting the product labels 192a-192f. Similarly, as shown in FIG. 9B, since the positional coordinates and exact location of each cropped image 186a-186f in the stitched image 187b that was processed (e.g., via optical recognition) are known, the control circuit 310 associates each of the products 190a-190f detected in the stitched image 187b with the characters extracted from the portions of the stitched image 187b corresponding to a respective one of cropped images 186a-186f respectively depicting the products 190a-190f.

The above-described exemplary embodiments advantageously provide for inventory management systems and methods, where individual price tag labels and products located on the product storage structures of product storage facilities of a retailer can be efficiently and cost-effectively detected, verified, and/or corrected (if needed). As such, the systems and methods described herein provide for an efficient, cost-effective, and precise recognition of product labels and products on the product storage structures of product storage facilities of large retailers, providing a significant cost savings to the retailers in terms of both saving thousands of worker hours that would be normally spent on manual on-hand product availability monitoring, as well as thousands/millions of dollars that would normally be spent on optical recognition of images of product labels and products stocked on the product storage structures of the product storage facilities of the retailer.

This application is related to the following applications, each of which is incorporated herein by reference in its entirety: entitled SYSTEMS AND METHODS OF SELECTING AN IMAGE FROM A GROUP OF IMAGES OF A RETAIL PRODUCT STORAGE AREA filed on Oct. 11, 2022, application Ser. No. 17/963,787 (attorney docket No. 8842-154648-US_7074US01); entitled SYSTEMS AND METHODS OF IDENTIFYING INDIVIDUAL RETAIL PRODUCTS IN A PRODUCT STORAGE AREA BASED ON AN IMAGE OF THE PRODUCT STORAGE AREA filed on Oct. 11, 2022, application Ser. No. 17/963,802 (attorney docket No. 8842-154649-US_7075US01); entitled CLUSTERING OF ITEMS WITH HETEROGENEOUS DATA POINTS filed on Oct. 11, 2022, application Ser. No. 17/963,903 (attorney docket No. 8842-154650-US_7084US01); entitled SYSTEMS AND METHODS OF TRANSFORMING IMAGE DATA TO PRODUCT STORAGE FACILITY LOCATION INFORMATION filed on Oct. 11, 2022, application Ser. No. 17/963,751 (attorney docket No. 8842-155168-US_7108US01); entitled SYSTEMS AND METHODS OF MAPPING AN INTERIOR SPACE OF A PRODUCT STORAGE FACILITY filed on Oct. 14, 2022, application Ser. No. 17/966,580 (attorney docket No. 8842-155167-US_7109US01); entitled SYSTEMS AND METHODS OF DETECTING PRICE TAGS AND ASSOCIATING THE PRICE TAGS WITH PRODUCTS filed on Oct. 21, 2022, application Ser. No. 17/971,350 (attorney docket No. 8842-155164-US_7076US01); entitled SYSTEMS AND METHODS OF VERIFYING PRICE TAG LABEL-PRODUCT PAIRINGS filed on Nov. 9, 2022, application Ser. No. 17/983,773 (attorney docket No. 8842-155448-US_7077US01); entitled SYSTEMS AND METHODS OF USING CACHED IMAGES TO DETERMINE PRODUCT COUNTS ON PRODUCT STORAGE STRUCTURES OF A PRODUCT STORAGE FACILITY filed Jan. 24, 2023, application Ser. No. 18/158,969 (attorney docket No. 8842-155761-US_7079US01); entitled METHODS AND SYSTEMS FOR CREATING REFERENCE IMAGE TEMPLATES FOR IDENTIFICATION OF PRODUCTS ON PRODUCT STORAGE STRUCTURES OF A RETAIL FACILITY filed Jan. 24, 2023, application Ser. No. 18/158,983 (attorney docket No. 8842-155764-US_7079US01); entitled SYSTEMS AND METHODS FOR PROCESSING IMAGES CAPTURED AT A PRODUCT STORAGE FACILITY filed Jan. 24, 2023, application Ser. No. 18/158,925 (attorney docket No. 8842-155165-US_7085US01); and entitled SYSTEMS AND METHODS FOR PROCESSING IMAGES CAPTURED AT A PRODUCT STORAGE FACILITY filed Jan. 24, 2023, application Ser. No. 18/158,950 (attorney docket No. 8842-155166-US_7087US01); entitled SYSTEMS AND METHODS FOR ANALYZING AND LABELING IMAGES IN A RETAIL FACILITY filed Jan. 30, 2023, application Ser. No. 18/161,788 (attorney docket No. 8842-155523-US_7086US01); entitled SYSTEMS AND METHODS FOR ANALYZING DEPTH IN IMAGES OBTAINED IN PRODUCT STORAGE FACILITIES TO DETECT OUTLIER ITEMS filed Feb. 6, 2023, Application No. (attorney docket No. 8842-155762-US_7083US01); entitled SYSTEMS AND METHODS FOR REDUCING FALSE IDENTIFICATIONS OF PRODUCTS HAVING SIMILAR APPEARANCES IN IMAGES OBTAINED IN PRODUCT STORAGE FACILITIES filed January, 2023, Application No. (attorney docket No. 8842-155763-US_7088US01); entitled SYSTEMS AND METHODS FOR IDENTIFYING DIFFERENT PRODUCT IDENTIFIERS THAT CORRESPOND TO THE SAME PRODUCT filed January, 2023, Application No. (attorney docket No. 8842-156079-US_7090US01); SYSTEMS AND METHODS OF UPDATING MODEL TEMPLATES ASSOCIATED WITH IMAGES OF RETAIL PRODUCTS AT PRODUCT STORAGE FACILITIES filed Jan. 30, 2023, application Ser. No. 18/102,999 (attorney docket No. 8842-156080-US_7092US01); and entitled SYSTEMS AND METHODS FOR DETECTING SUPPORT MEMBERS OF PRODUCT STORAGE STRUCTURES AT PRODUCT STORAGE FACILITIES, filed Jan. 30, 2023, application Ser. No. 18/103,338 (attorney docket No. 8842-156082-US_7094US01).

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A system for use in processing images of product labels and products located on a product storage structure of a product storage facility, the system comprising:
an image capture device having a field of view that includes at least a portion of the product storage structure and being configured to capture one or more images of the product storage structure; and
a computing device including a control circuit, the computing device being communicatively coupled to the image capture device, the control circuit being configured to:
obtain at least one image of the product storage structure captured by the image capture device;
analyze the at least one image of the product storage structure captured by the image capture device to detect at least one of individual ones of product labels and products located on the product storage structure;
crop each one of the detected individual products and each one of the detected individual product labels from the at least one image to generate a plurality of cropped images, each of the cropped images depicting an individual one of the detected products or an individual one of the detected product labels;
stitch together two or more of the cropped images to generate at least one stitched image;
receive one or more characters extracted from each of the products and each of the product labels detected in the at least one stitched image; and
associate, based on known positional coordinates of each of the products and each of the product labels in the at least one stitched image, the received one or more characters extracted from each one of the individual products and product labels detected in the at least one stitched image with corresponding ones of the plurality of cropped images of the products and product labels.

2. The system of claim 1, wherein the image capture device comprises a motorized robotic unit that includes wheels that permit the motorized robotic unit to move about the product storage facility, and a camera to permit the motorized robotic unit to capture the one or more images of the product storage structure.

3. The system of claim 1,
wherein the control circuit is programmed to generate a first set of virtual boundary lines in the at least one image, wherein each of the virtual boundary lines of the first set surrounds an individual one of the products detected in the at least one image; and
wherein the control circuit is programmed to generate a second set of virtual boundary lines in the at least one image, wherein each of the virtual boundary lines of the second set surrounds an individual one of the product labels detected in the at least one image.

4. The system of claim 3, wherein the at least one stitched image has a predetermined pixel size, and wherein the control circuit is programmed to determine a pixel size of each of the cropped images and to employ a first fit decreasing height algorithm to maximally populate the at least one stitched image with at least one of the cropped images.

5. The system of claim 4, wherein the control circuit is programmed to stitch at least two of the cropped images of the individual ones of the detected products and product labels to generate the at least one stitched image by implementing a synchronous architecture in combination with the first fit decreasing height algorithm.

6. The system of claim 4, wherein the control circuit is programmed to stitch at least two of the cropped images of the individual ones of the detected products and product labels to generate the at least one stitched image by implementing an asynchronous architecture in combination with the first fit decreasing height algorithm.

7. The system of claim 1, wherein the control circuit is programmed to assign a positional coordinate to each of the cropped images of at least one of the products and product labels populated into the at least one stitched image.

8. The system of claim 7, wherein the assigned positional coordinate is defined by x and y pixel ranges of the at least one stitched image containing each of the plurality of cropped images.

9. The system of claim 1, wherein the control circuit is programmed to receive the one or more characters extracted from each of the products and each of the product labels detected in the at least one stitched image together with positional coordinates of the one more characters within the at least one stitched image.

10. The system of claim 1, wherein, after the control circuit associates the received one or more characters extracted from each one of the individual products and product labels detected in the at least one stitched image with respectively corresponding ones of the plurality of cropped images of the products and product labels, the control circuit is programmed to make a prediction of which known product identifiers of the products stocked at the product storage facility present a match to the plurality of cropped images of the products and product labels.

11. A method of processing images of product labels and products located on a product storage structure of a product storage facility, the method comprising:
capturing one or more images of the product storage structure with an image capture device having a field of view that includes at least a portion of the product storage structure; and
by a computing device including a control circuit and being communicatively coupled to the image capture device:
obtaining at least one image of the product storage structure captured by the image capture device;
analyzing the at least one image of the product storage structure captured by the image capture device to detect at least one of individual ones of product labels and products located on the product storage structure;
cropping each one of the detected individual products and each one of the detected individual product labels from the at least one image to generate a plurality of cropped images, each of the cropped images depicting an individual one of the detected products or an individual one of the detected product labels;
stitching together two or more of the cropped images to generate at least one stitched image;
receiving one or more characters extracted from each of the products and each of the product labels detected in the at least one stitched image; and
associating, based on known positional coordinates of each of the products and each of the product labels in the at least one stitched image, the received one or more characters extracted from each one of the individual products and product labels detected in the at least one stitched image with corresponding ones of the plurality of cropped images of the products and product labels.

12. The method of claim 11, wherein the image capture device comprises a motorized robotic unit that includes wheels that permit the motorized robotic unit to move about the product storage facility, and a camera to permit the motorized robotic unit to capture the one or more images of the product storage structure.

13. The method of claim 11, further comprising, by the control circuit:
generating a first set of virtual boundary lines in the at least one image, wherein each of the virtual boundary lines of the first set surrounds an individual one of the products detected in the at least one image; and
generating a second set of virtual boundary lines in the at least one image, wherein each of the virtual boundary lines of the second set surrounds an individual one of the product labels detected in the at least one image.

14. The method of claim 13, wherein the at least one stitched image has a predetermined pixel size, and further comprising, determining, by the control circuit, a pixel size of each of the cropped images and to employ a first fit decreasing height algorithm to maximally populate the at least one stitched image with at least one of the cropped images.

15. The method of claim 14, further comprising stitching, by the control circuit, at least two of the cropped images of the individual ones of the detected products and product labels to generate the at least one stitched image by implementing a synchronous architecture in combination with the first fit decreasing height algorithm.

16. The method of claim 14, further comprising stitching, by the control circuit, at least two of the cropped images of the individual ones of the detected products and product labels to generate the at least one stitched image by implementing an asynchronous architecture in combination with the first fit decreasing height algorithm.

17. The method of claim 11, further comprising assigning, by the control circuit, a positional coordinate to each of the cropped images of at least one of the products and product labels populated into the at least one stitched image.

18. The method of claim 17, wherein the assigned positional coordinate is defined by x and y pixel ranges of the at least one stitched image containing each of the plurality of cropped images.

19. The method of claim 11, further comprising, receiving, by the control circuit, the one or more characters extracted from each of the products and each of the product labels detected in the at least one stitched image together with positional coordinates of the one more characters within the at least one stitched image.

20. The method of claim 11, further comprising, after the control circuit associates the received one or more characters extracted from each one of the individual products and product labels detected in the at least one stitched image with respectively corresponding ones of the plurality of cropped images of the products and product labels, making, by the control circuit, a prediction of which known product identifiers of the products stocked at the product storage facility present a match to the plurality of cropped images of the products and product labels.
